(19) United States
(12) Patent Application Publication
(10) Pub. No.: US 2004/0198587 A1
(43) Pub. Date: Oct. 7, 2004

(54) Organic microporous materials

(76) Inventors: Neil B McKeown, Stockport (GB); Saad Maksheed, Stockport (GB)

Correspondence Address: NIXON & VANDERHYE, PC, 1100 N GLEBE ROAD, 8TH FLOOR, ARLINGTON, VA, 22201-4714, US

(21) Appl. No.: 10/481,434

(22) PCT Filed: Jun. 21, 2002
(86) PCT No.: PCT/GB02/02838

(30) Foreign Application Priority Data
Jun. 21, 2001 (GB) 0115201.6

(51) Int. Cl. B01J 21/00; B01J 23/00; B01J 25/00; B01J 29/00; B32B 3/26; B01J 20/26

(52) U.S. Cl. 502/100; 502/402

(57) ABSTRACT

A microporous network material comprises a rigid 3-dimensional network of planer porphyrinic macrocycles in which pyrrole residues of adjacent macrocycles are connected by rigid linkers which restrain these adjacent macrocycles such that their porphyrinic planes are in a non-co-planar orientation. Material in accordance with the invention generally have a surface area of at least 300M² g⁻¹, e.g. in the range of 100-1000 m² g⁻¹. Preferred materials in accordance with the invention are phthalocyanine networks.

### FIELD OF INVENTION

The present invention relates to organic microporous materials and more particularly, but not exclusively, to such materials that by virtue of their surface area have applications as catalysts, adsorbents and chromatographic supports.

### BACKGROUND OF INVENTION

Most commercially used microporous materials are inorganic in nature and important examples of such materials include the zeolites.

Conventional zeolites and related nanoporous materials consist of a porous inorganic (e.g. silicate) lattice. Such materials are of significant technological importance as catalysts and adsorbents due to their high surface area (typically 500-700 m² g⁻¹). A large variety of zeolites are known and therefore the shape and size of the micropores (0.5-20 nm³) can be selected to suit the intended application. However, the scope for catalysis and adsorption offered by zeolites is limited by the uniform nature of the exposed inorganic surface. There is intense international interest in the creation of microporous structures composed of an organic porous framework. It is anticipated that such organic materials will offer an infinite variability of surface chemistry, pore size and pore shape. Ultimately, by careful design of in-built catalytic centres, such materials could mimic the sophisticated enzymatic systems found in Nature, such as the iron(II) porphyrin-containing cytochrome systems. However, to date, the advances towards the preparation of organic-based microporous structures have been modest. For example many research groups are studying organic materials composed of rigid molecules linked by non-covalent interactions such as metal-ligand or hydrogen bonding. These systems are well ordered and can be designed to possess pores in the size range 0.5-2 nm in diameter. However, the resulting structures are far too fragile for most applications—indeed most collapse when the solvent present during assembly is removed. In addition, the formation of large pores is prohibited by the interpenetration of one lattice within the pores of another. A different approach is the preparation of stable polymer networks composed of rigid segments such as triphenylcarbinols or 1,3,5-linked phenylenes. The presence of small voids in these materials was inferred by the absorption of argon. However rigid polymer networks have not provided large surface areas.

It would be particularly beneficial to provide microporous phthalocyanine (Pc) networks e.g. for use as catalysts. In order for Pc catalysts to function efficiently it is necessary for both oxygen (or an oxygen donor) and the reactant to have access to the active metal centres. Unsubstituted Pcs are very insoluble and therefore have to be used as heterogeneous catalysts with activity restricted to particulate surfaces. However, it is clear from the extensive literature on the subject that Pcs are unreliable heterogeneous catalysts with activity varying widely from batch to batch when obtained from the same supplier. Sulphonation or carboxylation of Pcs produces water-soluble derivatives with consistent homogeneous catalytic activity, however cofacial aggregation of the hydrophobic Pc unit limits their activity and they are incompatible with non-aqueous soluble reagents. Unfortunately, homogenous Pc catalysts suffer from self-oxidation of the Pc and problems associated with retrieval of the catalysts from the product.

Previously, Pcs have been immobilised onto polymer substrates and encapsulated within zeolites. Such supported catalysts offer improved recoverability and, for some systems, enhanced activity. In particular, zeolite encapsulation achieved by the in-situ cyclotetrarnerisation of phthalocyanine to form the Pc within the zeolite voids demonstrates beautifully the benefit of enforcing isolation of the Pc molecules—a feature which is present in the Pc networks. For example, each encapsulated Pc molecule can mediate the oxidation of 30 000 molecules of ethylbenzene at room temperature. In addition, the enforced isolation of zeolite encapsulation avoids the problem of self-oxidation encountered with homogeneous Pc catalysis. Unfortunately, the loading of Pc within zeolites is poor with at best only 1 in 6 cavities containing a Pc molecule. Other problems associated with zeolite-encapsulated Pcs include hindered access of large reactant molecules (e.g. PAHs) to the Pcs and a poor compatibility of the host with organic reactants although this can be improved by embedding the zeolite in a polymer membrane. In contrast to zeolite encapsulated Pcs, conventional polymer supported Pcs show poor activity. Partially, this failure is a result of using poorly defined systems prepared using crude methodology. In addition, it appears a common feature of polymer supported Pcs that high surface loading results in poor efficiency due to the formation of aggregates and therefore they provide no advantages as compared to particulate heterogeneous catalysis.

It is therefore an object of the invention to obviate or mitigate the abovementioned disadvantage.

### SUMMARY OF INVENTION

According to the present invention there is provided a microporous network material comprised of a rigid 3-dimensional network of planar porphyrinic macrocycles in which pyrrole residues of adjacent macrocycles are connected by rigid linkers which restrain these adjacent macrocycles such that their porphyrinic planes are in a non-co-planar orientation.

The porphrynic macrocycles may be of the formula I

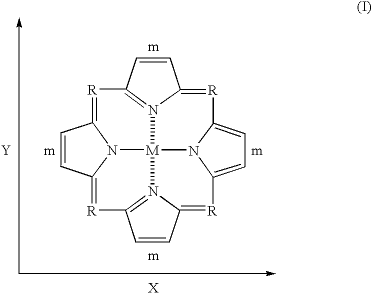

in which M represents a metal ion or 2H⁺ (for a metal free macrocycle), R is carbon or nitrogen, and m represents edges of the pyrrole residues to at least some of which the rigid linkers are attached to provide the three dimensional network, as described more fully below.

The illustrated macrocycle of formula (I) is a planar structure for which the porphyrinic plane is that denoted by XY.

In more detail, the invention provides “organic-based” microporous materials comprised of a 3-dimensional network of planar porphyrinic macrocycles covalently interconnected by linkers which impose a particular relative orientation on the macrocycle rings they interconnect. Each such linker may connect two or more of the macrocyclic rings together and in the overall network the substantial majority (but not necessarily all) of the macrocyclic rings will be associated with at least three, and ideally 4, linkers each of which in turn links that macrocycle to at least one adjacent macrocycle so as to build up the overall 3-dimensional network, which may preferably be represented by the following general formula (II).

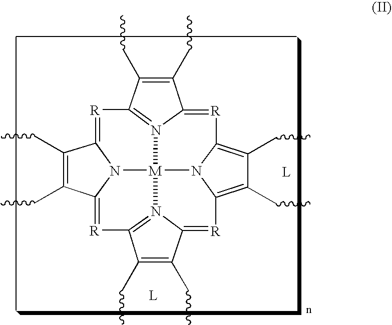

In the above formula, L represents a linker fused to, and connecting, pyrrole residues of adjacent porphyrinic macrocycles and M (if present) and R are as defined above.

The linkers L orient the macrocycles they covalently connect such that the porphyrinic plane of a macrocycle attached to the linker is not shared by that of the macrocycle to which it is connected by the linker. The porphyrinic plane (represented by the axes XY in Formula I) of any one macrocycle is the plane in which the four pyrrole residues of that (planar) macrocycle lie and is thus readily identifiable. Due to their flat, plate-like (or cross-like) shape, the non-coplanar orientation of the planes of adjacent macrocycles ensures a microporous structure. The rigid linker L maintains the non-coplanarity of the planes of adjacent macrocycles that would otherwise allow the colaesence of macrocycles and thus collapse the desired void space within the material.

The rigid linkers should be such that oligomeric molecules formed during polymerisation are not able to aggregate cofacially and give rise (undesirably) to a structure that fills space efficiently. As a result a large amount of interconnecting void space is produced. For this purpose it is preferred that the linkers L are such that the porphyrinic plane of one macrocycle does not intersect any portion of another macrocycle to which it is connected. Such linkers generate structures that do not fill space efficiently. Intersection can be readily determined by the constructions of a CPK molecular model of two macrocycle units joined by the linker. The bond angles in the model should not be distorted from those which would be found by single crystal x-ray diffraction structural analysis of compounds which contain the linking group as a component. The criteria to be adopted in determining intersection is whether the medial plane of one macrocycle intersects any portion of another macrocycle to which it is connected by the linker.

The invention is able to provide “robust” microporous materials of high surface area. This surface area may for example be in excess of 300 m² g⁻¹. The surface area may exceed 400 nm² g⁻¹ and may for example be in the range of 700-1000 m² g⁻¹ although the actual value area will be dependent on the particular linkers employed and the method used for preparation of the network.

The linkers may be such that the porphyrinic macrocycles they interconnect are orthogonal to each other. However whilst orthogonality represents a preferred embodiment of the invention it is not essential. It is possible for example for the porphyrinic planes of macrocycles connected by a linker to lie at angles of 60° to 90° to each other. It is also possible for the adjacent macrocycles connected by a linker to lie in parallel planes.

In preferred embodiments of the invention, as indicated above, the porphyrinic plane of a macrocycle connected by the linker does not intersect any portion of another macrocycle connected by that linker.

The material of the invention is most preferably a phthalocyanine network, the basic repeating phthalocyanine unit being of the following formula (III):

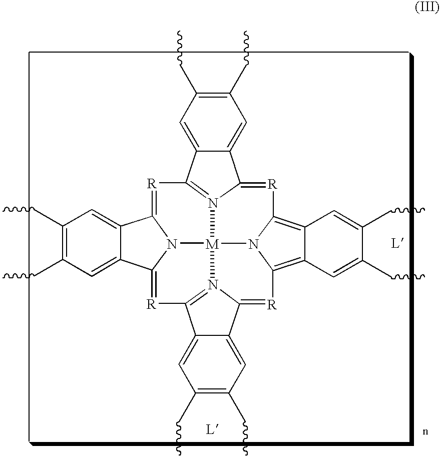

For consistency of terminology it should be understood that the moiety

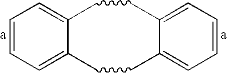

is fused via edge “a” to edge “m” in formula (I) to provide the linker L in formula (II).

The high surface area and robust nature of the organic microporous materials of the invention render them suitable for a wide variety of applications, e.g. of the type for which inorganic microporous materials such as zeolites are currently used. Thus, for example, the microporous materials in accordance with the invention may be used as catalysts, adsorbents and chromatographic supports. The preferred phthalocyanine networks of the invention may be used for catalytic reactions known to be catalysed by phthalocyanine per se. Further examples of uses for the materials of the invention include electro-optical applications.

### DESCRIPTION OF PREFERRED EMBODIMENT

As discussed above, the invention provides organic based microporous materials preferably represented by formula (II) above, and in particular (but not exclusively) phthalocyanine networks of formula (III), in which the porphyrinic macrocycles are orientated as discussed more fully above.

The linkers L in formula (II) preferably comprise extended planar fused ring systems (each preferably comprised of at least three fused rings, most preferably six-membered rings), connected by an “orientating moiety”. Each planar fused ring system is fused to a pyrrole residue of a respective one of the macrocycles connected by the linker so that it (the planar fused ring system) lies in the porphyrinic plane of that macrocycle. The “orientating moiety” by means of which the extended planar fused ring systems (of the linker) are connected provides for orientation of these ring systems and thus the macrocycles to which they are fused so as to provide for orientation of the latter as discussed above.

The extended fused ring systems may be of the formula (IV):

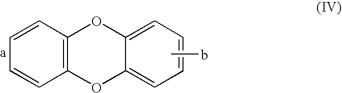

(where “a” represents the edge fused to the porphyrin via the edges “m” in formula (I) and “b” represents the bonding to the orientating moiety).

It will be appreciated that linkers incorporating extended fused ring systems (IV) provide phthalocyanine networks.

The orientating moiety connecting the terminal fused ring system of the linker L may include one or more centres having spatially constrained bonds that provide for orientation of the macrocycles. Thus, the centre or centres may be provided by a spiro-ring system whereof different rings are fused to the terminal fused ring systems.

The spiro-ring system may for example be a substituted or unsubstituted spiro-indane moiety of formula (V):

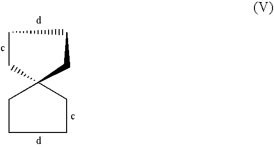

Preferably it is the sides “c” that are fused to the extended fused ring systems of the linker. Alternatively this spiro ring system may be fused to the extended ring system by its sides d, or by a combination of sides c and d on different rings.

A phthalocyanine network based on the above planar extended fused ring systems (IV) and a substituted spiro-indane unit (V) is of the general formula designated as (VI).

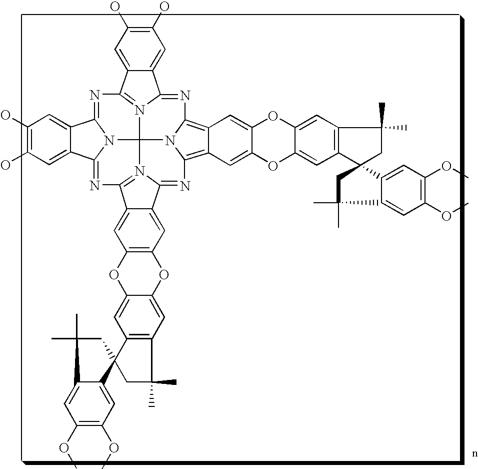

It will be appreciated from the above formula that porphyrinic macrocycles connected by a particular linker are orthogonal to each other with no portion of a macrocycle being intersected by the porphyrinic plane of another macrocycle to which it is connected by the linker.

In formula (VI) each porphyrinic macrocycle is connected by a linker incorporating a single spiro-indane moiety. It is however possible for the linker to comprise two or more spiro-indane moieties each fused to a fused ring system.

A further possibility for a centre having spatially constrained bonds for providing the required orientation of the macrocycles is a bridged ring entity the sides of which are fused directly to the porphyrinic macrocycles or via one planar fused ring system or two or three extended planar fused ring systems. The bridged ring system may be a bicyclo[2,2,2]octane ring (VII). A linker L incorporating a bicyclo[2,2,2]octane ring system and three extended fused ring systems (IV) (see above) has the structure shown in formula (VIII):

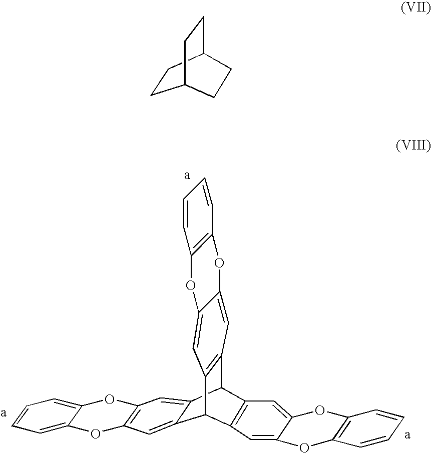

A further possibility is that the linker L is a tryptcene ring (VIIIa).

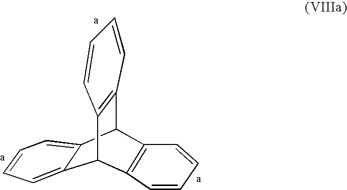

In formulae (VIII) and (VIIIa), the sides marked as “a” represent the sides fused via edges “m” in formula (I) to pyrrole residues of adjacent porphyrinic macrocycles.

As an alternative to the “orientating moiety” that connects the terminal fused ring systems of the linker incorporating spatially constrained bonds (as is the case of the spiro- and bridged ring systems discussed above), it is also possible for the required orientation to be provided by steric effects. Thus for example two planar fused ring systems (IV) may be connected by a single bond but have bulky substituents such that the desired orientation in the linker is enforced by the rigidity arising from restricted rotation about a single bond (atropisomerism). An example of a linker L based on this principle is illustrated as formula (IX):

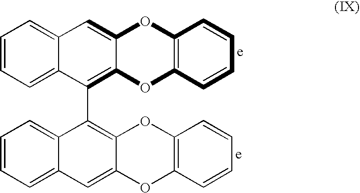

In this linker, the sides marked as “e” represent the sides fused to pyrrole residues of adjacent porphyrinic macrocycles.

In the above linker (IX), the planes of the two fused ring systems are at an angle of about 60°-70° relative to each other by virtue of the bulky naphthalene units.

Although phthalocyanine networks as represented by formula II (and as more specifically described above) represent preferred embodiments of the invention, there are other possibilities. Thus, for example a network in accordance with the invention may be of formula (IIa):

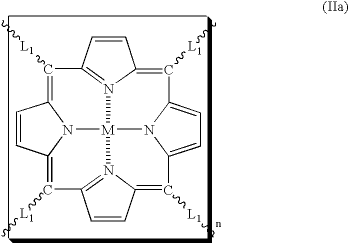

in which M is as defined for formula (II) and L₁ is a linker group designed in accordance with the principles discussed more fully above.

The linker L₁ connecting the two macrocycles may for example be comprised of two may for example be of the formula (IIb):

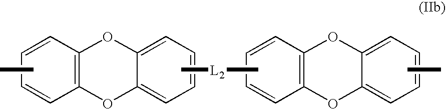

where L₂ is an orientating moiety.

L₂ may for example be one incorporating spatially constrained bonds such a spiro ring of formula (V) or a bicyclo[2,2,2]octane ring of formula (VII). Alternatively the orientating moiety may be one for which the desired orientation is enforced by rigidity arising from restricted rotation about a single bond (atropisomerism), e.g. an orientating moiety of the type depicted by formula (X).

All linkers employed in the present invention may be further substituted than otherwise specifically depicted.

Phthalocyanine networks (which are preferred networks in accordance with the invention) may be prepared by the metal ion mediated reaction of monomers containing two or more residues of phthalic acid or a derivative thereof (e.g. phthalonitrile, phthalic anhydride, phthalimide or diiminoisoindolene) connected by an appropriate linker system of the type discussed more fully above. The general reaction is illustrated below for monomers incorporating two phthalonitrile residues connected by an appropriate linker system L′ (cf formula (III) above):

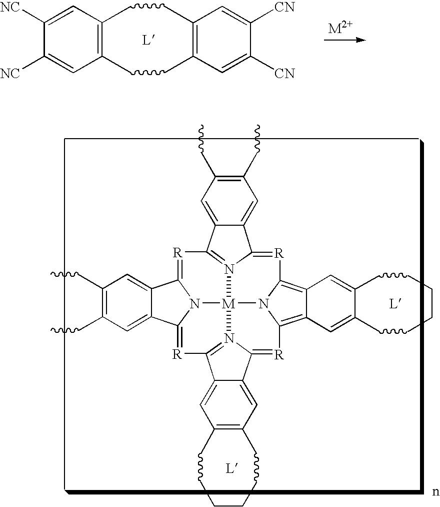

The metal ion in the above reaction scheme may for example be Co²⁺, Fe²⁺, Mn₂₊, Zn²⁺, Pd²⁺, Cu²⁺ or any metal ion, in any readily accessible oxidation state, derived from the seventy or so elements known to form complexes with porphyrins or phthalocyanines.

With the above considerations in mind, examples of suitable monomer units are of the formulae (X)-(XIV):

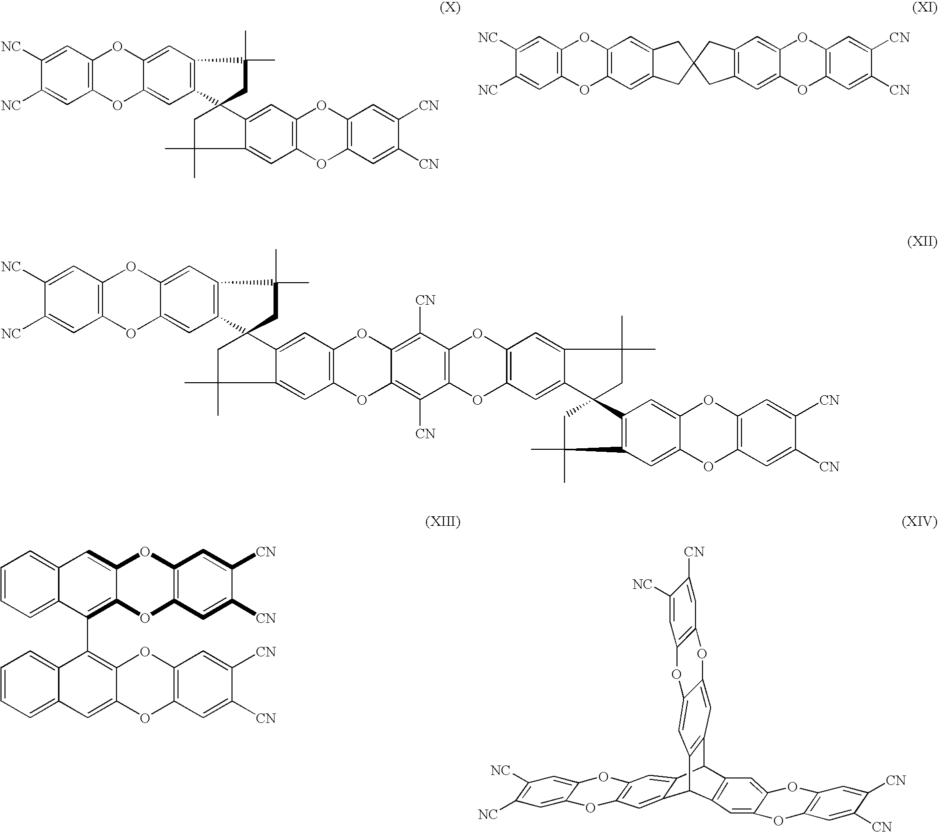

As a modification of the above reaction scheme the monomers (X)—(XIV) the phthalic acid derivative units may be replaced by dibromobenzene units and the reaction effected with copper (I) cyanide.

Highly branched polymers (i.e. hyperbranched polymers) may be prepared by using a mixture of suitable monomers containing two or more phthalocyanine forming units and a mono-reactive co-reagent that may contain at least one solubilising group.

Alternatively phthalocyanine networks may be formed by the reaction (depicted in the next reaction scheme) between preformed phthalocyanines containing reactive substituents (e.g. X) and a co-reactant so that the rigid porogenic linking group is obtained between neighbouring Pc units. The substituents X may be in the peripheral (2,3,9,10,16,17,23,24) or non-peripheral (1,4,8,11,15,18,22,25) benzo sites, or both. For example, X may be represented by fluorine atoms and Y by phenolic anions in an aromatic nucleophilic substitution reaction.

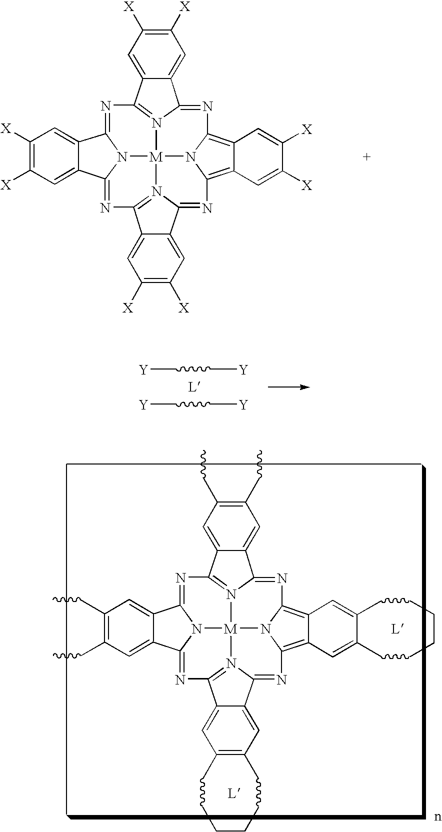

In a modification of the above reaction scheme, the preformed phthalocyanine may be formed with fused ring systems incorporating orientating moieties, the fused ring systems then being interconnected in the reaction to build up the overall network. An example of this strategy is shown in the following reaction scheme:

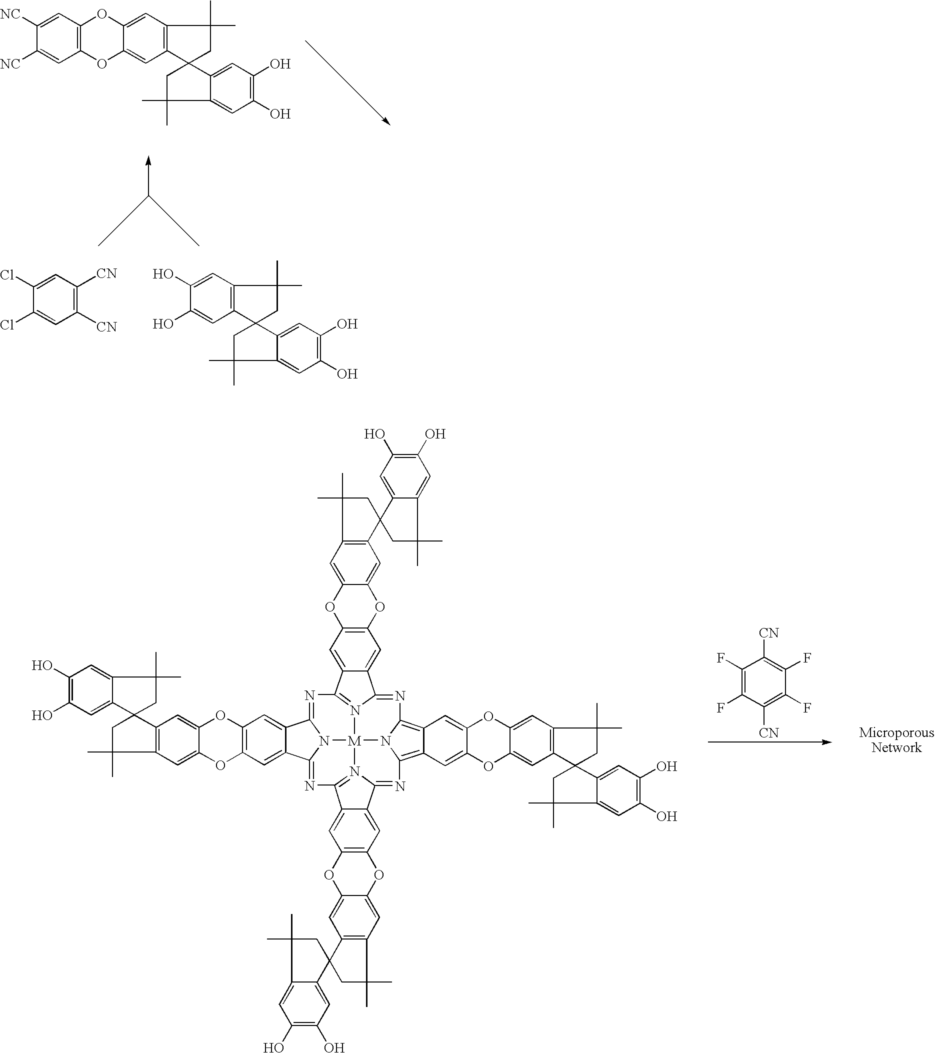

The microporous network materials of the invention have a variety of applications. For example, metal-free networks (prepared via a cyclotetramerisation reaction of a phthalonitrile-containing monomer using a labile metal-ion (e.g. Li⁺) which can be washed subsequently from the central cavity using water or dilute acid) have high affinity for all metal ions. Both metal-free and metal-containing networks have high affinity for certain types of organic compounds, especially large aromatic compounds, sulphides and amines. Therefore the high surface area of the networks make them suitable as adsorbents for toxic metal ions, polycyclic aromatic hydrocarbons (PAHs) and odorous compounds from aqueous industrial waste.

Applications include use as substrates for chromatography.

Further applications include use as catalysts. Thus for example phthalocyanines are established industrial catalysts that mediate a wide range of chemical reactions. For example, iron (II) and cobalt (II) phthalocyanines are a useful catalyst for the industrially important “sweetening” of crude petrochemicals by the aerobic oxidation of mercaptan impurities. Also they are of current interest as catalysts for the oxidation of hydrogen or methanol in fuel cells.

Phthalocyanines are also valuable catalysts for a range of useful chemical conversions. In particular their ability to activate oxygen and enable it to become a useful chemical reagent is especially significant in the context of replacing toxic and environmentally harmful oxidising agents. Examples of their utility include the conversion of phenols to quinones, alkenes to epoxides or carbonyls (e.g. the Wacker reaction) and alkanes to alcohols or ketones. It is anticipated that the phthalocyanine networks of the invention will be applicable in all of these applications as “substitutes” of the phthalocyanines conventionally used, with the large surface area and unrestricted access to the redox active metal-centres of the phthalocyanine networks providing enhanced activity.

Further applications of the network materials include the possibility of forming a conducting polymer within the voids of a phthalocyanine network. The intimate contact between the phthalocyanine (a photosensitiser) and the organic semi-conductor will lead to useful electro-optical materials.

Microporous networks in accordance with the invention may take a number of physical forms depending on their method of production and intended use. For example, the materials may be produced as irregular shaped particles in a precipitation reaction. Alternatively more regularly shaped particles may be produced by effecting network formation with emulsions. Further possibilities are thin films, continuous membrane and monolithic structures. As membranes the material may be used for the highly selective removal of substances from liquid and gaseous fields on an industrial scale. As monolith, the material have advantages over packed columns in chromatographic and other applications. It is possible to use high internal phase emulsions to give products in which the microporous material forms the walls of a highly ordered macroporous material so there is efficient mass transfer to the active sites.

The invention will be illustrated by the following non-limiting Examples and accompanying drawings, in which.

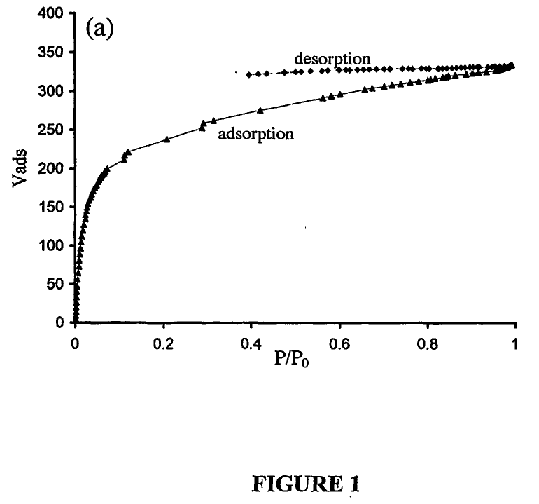

FIG. 1 illustrates a nitrogen adsorption/desorption plot for the network material obtained in Example 1.

Preparations

Preparation of Monomer (X)

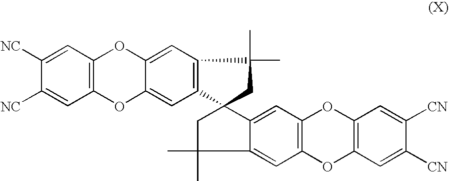

A mixture of anhydrous potassium carbonate, 3,3,3′,3′-tetramethyl-1,1″-spirobisindane-5,5′,6,6′-tetrol (5.0 g, 14.7 mmol) and 4,5-dichlorophthalonitrile (6.1 g, 30.1 mmol) in dry DMF (150 mL) was stirred at 71° C. for 18 h. On cooling, the mixture was added to water (300 mL) and the crude product collected by filtration. Recrystallisation from methanol gave 6.9 g (80%, yield) of the monomer. M.p. decomposes at ˜200° C.; (Found C, 73.35; H, 4.00; N, 9.01% C₃₇H₂₄N₄O₄.H₂O requires C, 73.25; H, 4.35; N, 9.24%); δH (300 MHz, d₆-DMSO): 1.28 (6H, s), 1.36 (6H, s), 2.14 (2H, d), 2.28 (2H, s), 6.39 (2H, s), 6.98 (2H, s), 7.75 (2H, s), 7.82 (2H, s);); m/z (ES) 611 (M⁻+Na⁺),

Preparation of Monomer (XII)

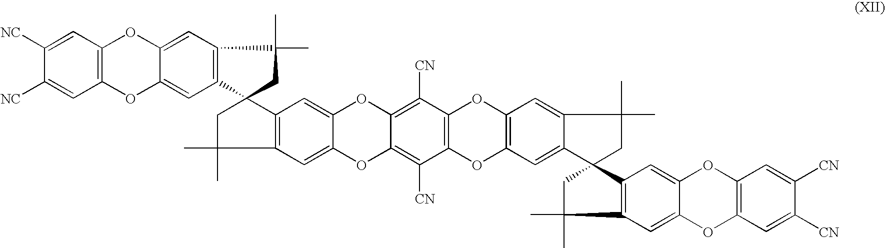

A mixture of anhydrous potassium carbonate, 3,3,3′,3′-tetramethyl-1,1″-spirobisindane-5,5′,6,6′-tetrol (5.0 g, 14.7 mmol) and 1,4-dicyano-2,3,5,6-tetrafluorobenzene (0.5 g, 2.0 mmol) in dry DMF (150 mL) was stirred at 50° C. for 18 h. An excess of 4,5-dichlorophthalonitrile (8.0 g, 40.1 mmol) was added and the reaction continued for a further 18 h. On cooling, the mixture was added to water (300 mL) and the crude product collected by filtration. The mixture was heated in dichloromethane and allowed to cool. A large quantity of monomer X is formed as a byproduct (˜6 g). This compound is insoluble in dichloromethane and can be collected by filtration. The solvent is removed and the residue recrystallised from methanol (×3) to give monomer XII; yield=1.5 g, 75% M.p. decomposes at ˜200° C.; (Found C, 74.35; H, 4.00; N, 8.01% C₆₄H₄₄N₈O₄ requires C, 74.99; H, 4.33; N, 7.98%); δH(300 MHz, d₆-DMSO): 1.2-1.3 (12H, m), 1.4-1.6 (12H, m), 2.10-2.20 (4H, m), 2.3-2.5 (4H, m), 6.30-6.40 (4H, s), 6.90-7.05 (4H, s), 7.75 (4H, d), 7.82 (4H, d); m/z (ES) 1048 (M⁻+Na⁺),

### EXAMPLE 1

A mixture of monomer (X) (0.6 g, 1 mmol) and anhydrous zinc (II) acetate (0.19 g, 1 mmol) in dry quinoline (2 mL) was heated at 220° C. Almost immediately, the mixture turned dark and in less than 2 hours a precipitate is formed which made stiring impossible. On cooling, the solid (0.6 g) was collected by filtration, washed exhaustively using a Soxhlet extractor in hot Methanol, then hot THF and then dried in vacuo; (Found C, 65.05; H, 3.87; N, 7.62; Zn, 6.71%); λₘₐₓ(DMF) 678 nm; surface area (N₂ adsorption)=954 m² g⁻¹ (see also FIG. 1). Electron microscopy indicates irregular-shaped particles of dimensions in the range 10-50 microns.

### EXAMPLE 2

A mixture of monomer (X) (0.6 g, 1 mmol) and anhydrous cobalt (II) acetate (0.19 g, 1 mmol) in dry quinoline (2 mL) was heated at 220° C. Almost immediately, the mixture turned dark and in less than 2 hours a precipitate is formed which made stirring impossible. On cooling, the solid (0.65 g) was collected by filtration, washed exhaustively using a Soxhlet extractor in hot Methanol, then hot THF and then dried in vacuo: surface area (N₂ adsorption)=489 m² g⁻¹.

### EXAMPLE 3

A mixture of monomer (X) (0.6 g, 1 mmol) was dissolved in refluxing pentanol (2 mL) and excess lithium metal was added (˜50 mg). Almost immediately after the lithium dissolved, the mixture turned dark and in less than 0.5 h a precipitate is formed which made stirring impossible. On cooling, the solid (0.65 g) was collected by filtration, washed exhaustively using a Soxhlet extractor with hot Acetic acid, hot methanol, then hot THF and then dried in vacuo; (Found C, 69.25; H, 4.5; N, 7.83); λₘₐₓ(DMF) 668 and 695 nm; surface area (N₂ adsorption)=535 m² g⁻¹.

### EXAMPLE 4

A mixture of monomer (XII) (1.05 g, 1 mmol) and anhydrous zinc (II) acetate (0.19 g, 1 mmol) in dry quinoline (2 mL) was heated at 220° C. Almost immediately, the mixture turned dark and in less than 2 hours a precipitate is formed which made stirring impossible. On cooling, the solid (9.8 g) was collected by filtration, washed exhaustively using a Soxhlet extractor in hot methanol, then hot THF and then dried in vacuo; λₘₐₓ(D)M 678 nm; surface area N₂ adsorption)=516 m² g⁻¹.

### EXAMPLE 5

A mixture of monomer (X) (0.5 g, 0.83 mmol), 1,3-di-tert-butyl-7,8-dicyanodibenzodioxine (0.57 g, 1.66 mmol) and anhydrous zinc (II) acetate (0.3 g, 3 mmol) in dry quinoline (2 mL) was heated at 190° C. Almost immediately, the mixture turned dark and stirring was continued at this temperature for a further 5 h to give a very dark green viscous solution. On cooling, the solution was added to methanol and collected by filtration. The material was washed exhaustively using a soxhlet extractor in hot methanol then hot THF to remove the soluble phthalocyanine products and then dried in vacuo; surface area=560 m² g⁻¹.

### EXAMPLE 6

This Example describes preparation of a porphyrin network from a preformed macrocycle in accordance with the following reaction scheme:

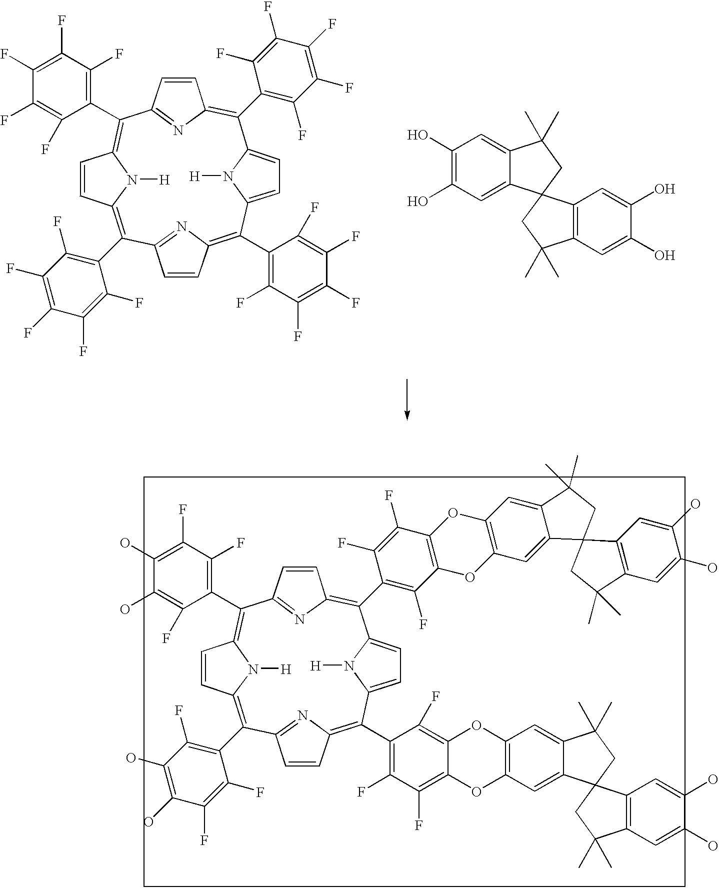

A mixture of 3,3,3′,3′-tetramethyl-1,1″-spirobisindane-5,5′,6,6′-tetrol (42 mg, 0.12 mmol) and 5,10,15,20-tetra(2,3,4,5,6-pentafluorophenyl)porphyrin (60 mg, 0.06 mmol) in dry DMF (2 mL) was heated at 100° C. for 24h. On cooling, the solid (100 mg) was collected by filtration, washed exhaustively using a Soxhlet extractor in hot methanol, then hot THF and then dried in vacuo; λₘₐₓ(1-chloronapthalene) 410 nm; surface area (N₂ adsorption)=320 m² g⁻¹.

### EXAMPLE 7

This example describes preparation of a phthalocyanine network in accordance with the following reaction scheme:

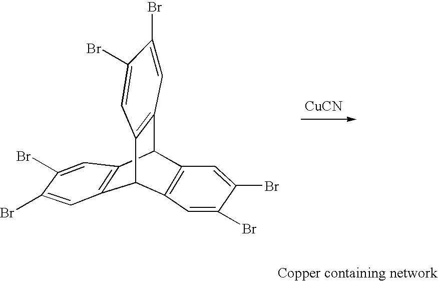

A mixture of hexabromotriptycene (0.5 g, 0.7 mmol) and copper cyanide (0.26 g, 0.30 mmol) in dry DMF (5 mL) was heated at 140° C. for 24h. On cooling, the solid (150 mg) was collected by filtration, washed exhaustively using a Soxhlet extractor in hot methanol, then hot THF and then dried in vacuo; λₘₐₓ(1-chloronapthalene) 714 run; surface area (N₂ adsorption)=450 m² g⁻¹.

1. A microporous network material comprised of a rigid 3-dimensional network of planar porphyrinic macrocycles in which pyrrole residues of adjacent macrocycles are connected by rigid linkers which restrain these adjacent macrocycles such that their porphyrinic planes are in a non-co-planar orientation.

2. A material claimed in claim 1 having a surface area of at least 300 m² g⁻¹.

3. A material as claimed in claim 2 having a surface area of at least 400 m² g⁻¹.

4. A material as claimed in claim 3 having a surface area of 700-1000 m² g⁻¹.

5. A material as claimed in any one of claims 1 to 4 which is a phthalocyanine network.

6. A material as claimed in any one of claims 1 to 5 wherein the adjacent macrocycles are orthogonal to each other.

7. A material as claimed in any one of claims 1 to 6 wherein the adjacent macrocycles connected by a linker are orientated such that the porphyrinic plane of one macrocycle does not intersect any portion of another macrocycle to which it is connected by the linker.

8. A material as claimed in claim 7 wherein the linkers comprise planar fused ring systems connected by an at least one “orientating moiety” which provides for orientation of these rings systems such that the porphyrinic plane of one macrocycle is not co-planar with that another macrocycle to which it is connected by the linker.

9. A material as claimed in claim 8 wherein the fused ring systems of the linker each comprise at least three fused rings.

10. A material as claimed in claim 8 or 9 wherein the fused rings of the linker are six-membered rings.

11. A material as claimed in claim 10 wherein the terminal fused ring systems are of the formula (III): 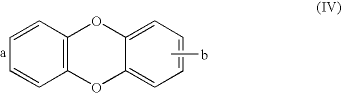
where “a” represents the side fused to the pyrrole residue and “b” represents the bonding to the orientating moiety.

12. A material as claimed in any one of claims 8 to 11 wherein the “orientating moiety” is a substituted or unsubstituted spiro-indane moiety of formula (IV): 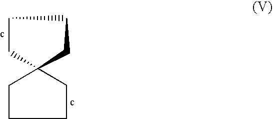
where the sides “c” are those sides that are fused to planar fused ring systems of the linker.

13. A material as claimed in claim 12 which is a phthalocyanine network of the formula (V):

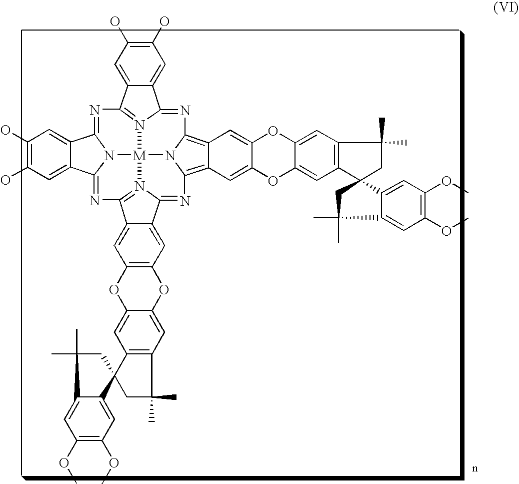

14. A material as claimed in any one of claims 8 to 11 wherein the “orientating moiety” is a bridged ring entity to the sides of which are fused the terminal planar ring systems of the linker.

15. A material as claimed in claim 14 wherein the bridged ring system is a bicyclo[2,2,0]octane ring.

16. A material as claimed in claim 15 wherein the linker is of the formula (VIII): 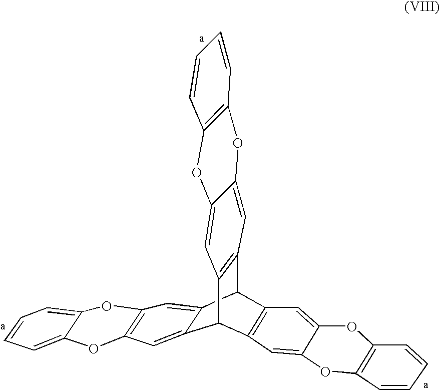
where “a” represents the sides fused to pyrrole residues of adjacent porphyrinic macrocycles.

17. A material as claimed in any one of claims 8 to 11 wherein the orientation within the linker is provided by steric effects.

18. A material as claimed 17 wherein the linker is of the formula (IX): 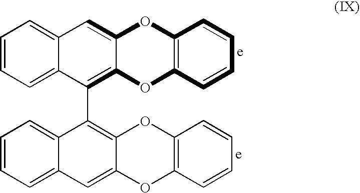
wherein “e” represents sides of the linker fused to pyrrole residues of adjacent porphyrinic macrocycles.

19. A material as claimed in claim 1 which is of the general formula: 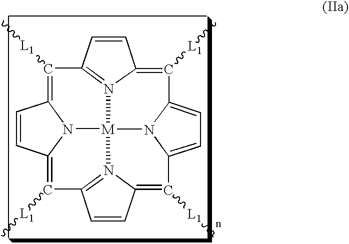
in which M represents a metal ion or 2H⁺ (for a metal free macrocycle) and L₁ is a linker group.

20. A method of producing a material as claimed in any one of claims 1 to 18 by the metal ion mediated reaction of monomers containing two or more residues of phthalic acid or a derivative thereof connected by an appropriate linker system of the type defined in any one of the preceding claims.
